(19) United States
(12) Patent Application Publication
(10) Pub. No.: US 2021/0046511 A1
(43) Pub. Date: Feb. 18, 2021

(54) FERROMAGNETIC TAGGING OF SELECTED ITEMS

(71) Applicant: SAMUEL SPECTOR, EDISON, NJ (US)

(72) Inventor: SAMUEL SPECTOR, EDISON, NJ (US)

(21) Appl. No.: 16/543,594

(22) Filed: Aug. 18, 2019

(51) Int. Cl. B07C 5/344; B07C 5/02; B29B 17/02

(52) U.S. Cl. CPC B07C 5/344; B29B 2017/0262; B29B 17/02; B07C 5/02

(57) ABSTRACT

Ferromagnetic items (e.g., tags, bands, labels containing iron/steel powder) are attached to selected non-ferromagnetic apparatus (e.g., plastic bottles, plastic bags) so that a magnetic device can be used to sort out the non-ferromagnetic apparatus to which the ferromagnetic item is attached.

This invention claims priority based on provisional application Ser. No. 62/766,920 filed Nov. 13, 2018 titled ADDING STEEL BANDS TO PLASTIC BOTTLE AND STEEL TAGS TO PLASTIC BAGS.

### BACKGROUND OF THE INVENTION

The mechanical separation of waste materials is becoming increasingly important for both the environment and the economy. In many instances, such as when recycling trash, it is desirable to be able to sort out certain items. For example, it may be desirable to sort plastic materials (e.g., plastic bottles and plastic bags) out of other trash. The difficulty and cost of manually sorting or extracting certain items such as plastic bottles and plastic bags from other items such as textile and paper products may be very significant.

Many of the sorting problems associated with non-ferromagnetic materials may be resolved in keeping with Applicant's invention.

### SUMMARY OF THE INVENTION

Applicant's invention, is directed to attaching ferromagnetic items (e.g., tags, bands, labels containing iron/steel powder) to selected non-ferromagnetic apparatus (e.g., plastic bottles, plastic bags) so that a magnetic device can be used to sort out the non-ferromagnetic apparatus to which the ferromagnetic item is attached.

In the discussion to follow and in the claims appended hereto, materials that can be attracted to, or by, a magnet, are called ferromagnetic (or ferrimagnetic). These materials include the elements iron, nickel and cobalt and their alloys, some alloys of rare-earth metals, and some naturally occurring minerals such as lodestone.

### BRIEF DESCRIPTION OF THE DRAWINGS

In the accompanying drawings like reference characters denote like components and

FIG. 1 is an isometric drawing of a plastic bottle with an iron band formed around a portion of the bottle;

FIG. 2 is a drawing of part of a plastic bag to which iron tags have been attached; and

FIG. 3 is a drawing of a label one side of which includes iron particles and ferromagnetic strips which can be attached to selected items.

### DETAILED DESCRIPTION OF THE INVENTION

In the description to follow, the invention is illustrated using bands, tags and labels which include, or are made of, iron (steel) or iron particles. However, it should be understood that this is for purpose of description and that any material that can be attracted to, or by, a magnet is suitable for use. That is, any material that has the property of being attracted to a magnet is defined as being in a class called “ferromagnetic” and can be used to practice the invention. The suitable elements include iron, any alloy of iron (e.g., steel), nickel and cobalt and their alloys, some alloys of rare-earth metals, and some naturally occurring minerals such as lodestone. With respect to iron, ferrous metal is defined as any metal that contains iron. Ferrous metals are very common due to the heavy use of iron in most metal alloys. Ferrous metals contain a large enough iron content to create enough domains for a magnetic field to act on and attract. Ferrous materials are the only objects that are physically attracted to magnetic fields.

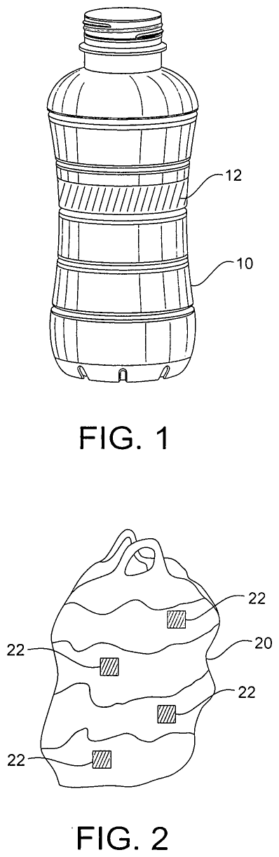

Referring to FIG. 1, there is shown a bottle 10 made of plastic material with a steel band 12 wrapped around the bottle. As noted above the steel band is a ferromagnetic material and any ferromagnetic material could be used instead of the steel band In accordance with the invention, the ferromagnetic material can be attached by any known means to a non-ferromagnetic apparatus. Note that it is within the contemplation of the invention to even form non-ferromagnetic apparatus with a ferromagnetic portion to practice the invention. That is, ferromagnetic items can be formed independently of a non-ferromagnetic apparatus and then fixedly attached by any known suitable means. Alternatively, some non-ferromagnetic apparatus can be formed integrally with a ferromagnetic portion.

Referring to FIG. 2 there is shown a plastic bag 20 with steel tags 22 attached to the bag 20. The tags may of course be made of any ferromagnetic material.

The bands 12 and the tags 22 may be very thin adding little weight to the apparatus to which they are attached. The size of the bands and tags need to be just large enough to enable a magnetic device to sort or extract the non-ferromagnetic apparatus (e.g., 10, 20) to which they are attached. The magnetic device (not shown) may be any suitable magnet or electromagnetic device.

By way of example, consider non-ferromagnetic apparatus (e.g., 10, 20) modified as per the invention and other waste products flowing down a conveyor belt (not shown). The non-ferromagnetic apparatus, as modified per the invention, now may be pulled towards one side of the conveyor belt by a magnetic device located along the one side of the conveyor belt. Another example, may be a magnetic device (not shown) which can hover over a pile of non-ferromagnetic apparatus (e.g., 10, 20) modified as per the invention, where the magnetic device can be used to sort or extract the non-ferromagnetic apparatus (e.g., 10, 20) modified as per the invention.

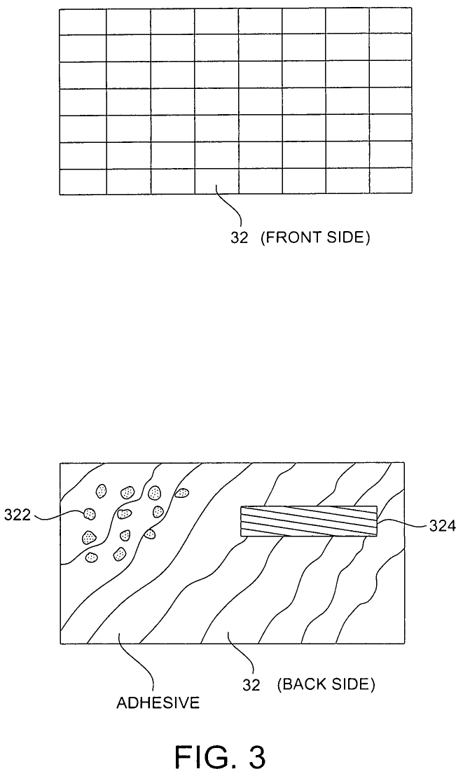

Referring to FIG. 3 there is shown a label 32 which can be attached to selected apparatus (e.g., 10, 20) by means of a glue or any suitable adhesive which includes iron or steel particles 322 or any type of ferromagnetic strip 324.

The invention has been illustrated using plastic apparatus to which the ferromagnetic item is attached. However it should be understood that the ferromagnetic item may be attached to any non-ferromagnetic apparatus (e.g., textile, paper) to practice the invention.

What is claimed is:

1. A combination comprising:
a non-ferromagnetic apparatus; and
a ferromagnetic item attached to said non-ferromagnetic apparatus to enable a magnet to attract the non-ferromagnetic apparatus.

2. The combination as claimed in claim 1, wherein the non-ferromagnetic apparatus is made of a plastic material and the ferromagnetic item is of a ferrous material.

3. The combination as claimed in claim 1, wherein the non-ferromagnetic apparatus is a plastic bottle and the ferromagnetic item is band of ferrous material attached to said bottle.

4. The combination as claimed in claim 1, wherein the ferromagnetic item is a band of ferrous material.

5. The combination as claimed in claim 1, wherein the ferromagnetic item is a tag of ferrous material.

6. The combination as claimed in claim 1, wherein the ferromagnetic item is a label which includes ferrous material.

7. The combination as claimed in claim 1, wherein the non-ferromagnetic apparatus is a plastic bag and the ferromagnetic item is a strip of ferrous material attached to said plastic bag.

8. A system for sorting non-ferromagnetic materials from other materials comprising the steps of:
attaching a ferromagnetic item attached to selected non-ferromagnetic apparatus to enable a magnet to attract the selected non-ferromagnetic apparatus; and
using a magnetic device to attract the selected non-ferromagnetic apparatus.

9. The system as claimed in claim 8 wherein said non-ferromagnetic apparatus is comprised of plastic materials.
